(19) United States
(12) Patent Application Publication
(10) Pub. No.: US 2024/0028977 A1
(43) Pub. Date: Jan. 25, 2024

(54) SHARING MANAGEMENT DEVICE AND SHARING SYSTEM

(71) Applicant: TOYOTA JIDOSHA KABUSHIKI KAISHA, Aichi-ken (JP)

(72) Inventor: Ai MIYATA, Sakai-shi (JP)

(21) Appl. No.: 18/353,887

(22) Filed: Jul. 18, 2023

(30) Foreign Application Priority Data
Jul. 25, 2022 (JP) 2022-117923

(51) Int. Cl. G06Q 10/02; G08G 1/14

(52) U.S. Cl. CPC G06Q 10/02; G08G 1/149

(57) ABSTRACT

A vehicle moving from a first parking lot having one or more parking spaces to a second parking lot having one or more parking spaces is referred to as an operated vehicle. A vehicle different from the operated vehicle is referred to as a different vehicle. A sharing management device is configured to execute a first setting process that sets one of the one or more parking spaces in the second parking lot to be unavailable for the different vehicle before the operated vehicle departs from the first parking lot toward the second parking lot and a second setting process that sets one of the one or more parking spaces in the first parking lot to be available for the different vehicle from when the operated vehicle departs from the first parking lot toward the second parking lot to when the operated vehicle arrives at the second parking lot.

### BACKGROUND

### 1. Field

The present disclosure relates to a sharing management device and a sharing system.

### 2. Description of Related Art

Japanese Laid-Open Patent Publication No. 2019-159689 discloses a car sharing management device. The car sharing management device determines whether to reserve a vehicle based on the situation of parking spaces in a parking lot for the vehicle.

Upon a request for a reservation for the use of a vehicle that moves from a first parking lot to a second parking lot, the car sharing management device disclosed in the above publication completes the reservation for the use if a vacant parking space is included in the second parking lot. However, the above publication does not disclose how to handle availability of the parking spaces in each parking lot during movement of the vehicle from the first parking lot to the second parking lot. Accordingly, there is a demand for a management technique of using parking spaces in each parking lot more efficiently during movement of the vehicle.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A sharing management device according to an aspect of the present disclosure is configured to perform management for a user to share a parking space in a parking lot. A vehicle moving from a first parking lot having one or more parking spaces to a second parking lot having one or more parking spaces is referred to as an operated vehicle. A vehicle that is different from the operated vehicle is referred to as a different vehicle. The sharing management device includes processing circuitry configured to execute a first setting process that sets one of the one or more parking spaces in the second parking lot to be unavailable for the different vehicle before the operated vehicle departs from the first parking lot toward the second parking lot and a second setting process that sets one of the one or more parking spaces in the first parking lot to be available for the different vehicle from when the operated vehicle departs from the first parking lot toward the second parking lot to when the operated vehicle arrives at the second parking lot.

Other features and aspects will be apparent from the following detailed description, the drawings, and the claims.

### BRIEF DESCRIPTION OF DRAWINGS

FIG. 1 is a schematic diagram of a car sharing system.

FIG. 2 is a diagram illustrating movement of the operated vehicle in the car sharing system shown in FIG. 1.

FIG. 3 is a flowchart illustrating a series of processes in the management program of the car sharing system shown in FIG. 1.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### Configuration of Embodiment

A car sharing system 10 to which a sharing system including a sharing management device is applied will now be described with reference to the drawings.

### Schematic Configuration of Car Sharing System

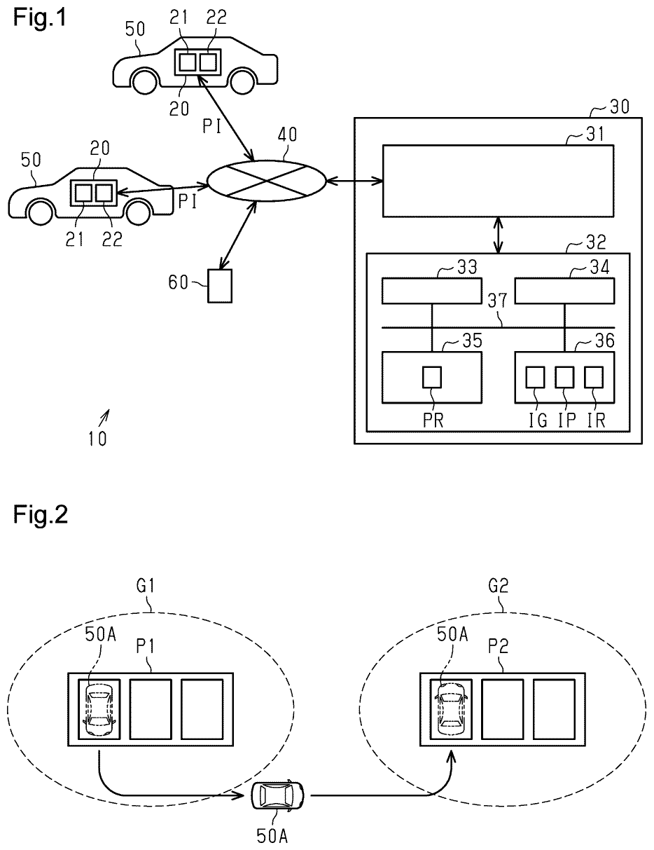

As shown in FIG. 1, the car sharing system 10 includes client terminals 20 and a server 30. The server 30 is connected to one or more client terminals 20 via an external communication network 40. The external communication network 40 is, for example, a wireless communication network such as a mobile phone network. Thus, the client terminals 20 and the server 30 can communicate information with each other via the external communication network 40.

Each client terminal 20 is a vehicle on-board device attached to the vehicle 50. The client terminal 20 includes a position information acquisition device 21 and a transmission device 22. The position information acquisition device 21 acquires position information PI indicating the position of a vehicle 50 based on, for example, a signal from a global navigation satellite system (GNSS). The position information PI indicates the latitude, longitude, and altitude of the vehicle 50. The transmission device 22 repeatedly sends the position information PI of the vehicle 50 acquired by the position information acquisition device 21 to the server 30 at intervals of, for example, one minute. The vehicle 50 is a target vehicle to be shared by a user in the car sharing system 10.

The server 30 includes a transmission-reception device 31 and a sharing management device 32. The transmission-reception device 31 receives the position information PI of the vehicle 50 sent from the transmission device 22 of each client terminal 20. That is, the transmission-reception device 31 functions as a reception device that receives the information sent from the transmission device 22 of the client terminal 20. The transmission-reception device 31 sends the received position information PI of the vehicle 50 to the sharing management device 32.

The sharing management device 32 is used to perform management for users to share parking spaces in a parking lot. The sharing management device 32 includes a CPU 33 that is an execution device, peripheral circuitry 34, a ROM 35, a storage device 36, and a bus 37. The bus 37 connects the CPU 33, the peripheral circuitry 34, the ROM 35, and the storage device 36 such that they can communicate with each other. The peripheral circuitry 34 includes a circuit that generates a clock signal that defines the operation of the sharing management device 32, a power supply circuit, a reset circuit, and the like. The ROM 35 stores, in advance, programs necessary for the CPU 33 to execute various controls. Specifically, the ROM 35 stores a management program PR. The CPU 33 executes various processes in accordance with various programs stored in the ROM 35. The processes defined in the management program PR will be described later.

The storage device 36 stores reservation information IR of the vehicles 50 used in the car sharing system 10. Specifically, the storage device 36 stores information indicating whether each vehicle 50 is in a reserved state as the reservation information IR. The storage device 36 stores, as the reservation information IR, information indicating a parking lot from which the vehicle 50 in the reserved state will depart and information indicating a parking lot at which that vehicle 50 will arrive.

The storage device 36 stores parking lot information IP related to parking lots used in the car sharing system 10. Each parking lot has one or more parking spaces. The storage device 36 stores, as the parking lot information IP, information indicating whether each parking space in the parking lot is available. The storage device 36 also stores, as the parking lot information IP, the number of parking spaces that are available in each parking lot.

The storage device 36 stores geofence information IG indicating a geofence for each parking lot. Each geofence is set as a range that includes one of parking lots and does not include the other parking lots. Each geofence is set so as not to overlap with the other geofences.

### Series of Processes by Management Program

Upon a reservation request for each vehicle 50 from the user, the sharing management device 32 of the CPU 33 executes the management program PR. The reservation request from the user is made by the user operating an operation terminal 60. When the operation terminal 60 is operated, a signal indicating the reservation request is sent from the operation terminal 60 to the server 30 via the external communication network 40. Then, when the server 30 receives the signal indicating the reservation request, the CPU 33 determines that the reservation request has been received and executes the management program PR. The operation terminal 60 is, for example, a smartphone.

The signal indicating the reservation request for the vehicle 50 includes information indicating the parking lot from which the vehicle 50 will depart and information indicating the parking lot at which the vehicle 50 will arrive. As shown in FIG. 2, one of parking lots from which the vehicle 50 will depart is referred to as a first parking lot P1, and one of the parking lots at which the vehicle 50 will arrive is referred to as a second parking lot P2. Of the vehicles 50, a vehicle that moves from the first parking lot P1 to the second parking lot P2 is referred to as an operated vehicle 50A. Of the vehicles 50, a vehicle that is different from the operated vehicle 50A is referred to a different vehicle.

In the following description, setting a parking space to be available means storing the parking lot information IP in the storage device 36 as a state indicating that the parking space is available. Setting a parking space to be unavailable means storing the parking lot information IP in the storage device 36 as a state indicating that the parking space is unavailable.

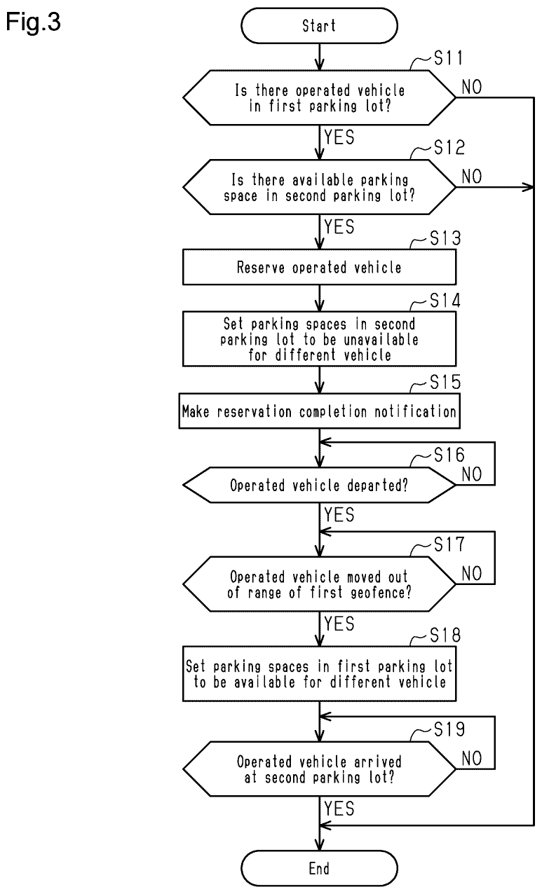

As shown in FIG. 3, the CPU 33 first performs the process of step S11 in accordance with the management program PR. In step S11, the CPU 33 determines whether there is an available vehicle 50 in the first parking lot P1. Specifically, the CPU 33 refers to the reservation information IR in the storage device 36 to determine whether an unreserved vehicle 50 is parked in the first parking lot P1. When the unreserved vehicle 50 is parked in the first parking lot P1, the CPU 33 determines that there is an available operated vehicle 50A in the first parking lot P1. When the unreserved vehicle 50 is not parked in the first parking lot P1, the CPU 33 determines that there is no available operated vehicle 50A in the first parking lot P1. When determining that there is no available operated vehicle 50A in the first parking lot P1 (S11: NO), the CPU 33 sends a signal indicating that reservation cannot be made to the operation terminal 60. Then, the CPU 33 terminates the series of processes. When there is an available operated vehicle 50A in the first parking lot P1 (S11: YES), the CPU 33 advances the process to step S12.

In step S12, the CPU 33 refers to the parking lot information IP of the storage device 36 to determine whether there is an available parking space in the second parking lot P2. Specifically, when the number of available parking spaces in the second parking lot P2 is one or more, the CPU 33 determines that the parking space in the second parking lot P2 is available for the operated vehicle 50A. When there is no available parking space in the second parking lot P2 (S12: NO), the CPU 33 sends a signal indicating that reservation cannot be made to the operation terminal 60 of the user. Then, the CPU 33 terminates the series of processes. When there is an available parking space in the second parking lot P2 (S12: YES), the CPU 33 advances the process to step S13.

In step S13, the CPU 33 performs a reservation process that reserves the operated vehicle 50A. In step S13, when affirmative determinations are made in the above steps S11 and S12, the operated vehicle 50A is reserved. That is, the reservation process is a process that reserves the operated vehicle 50A on condition that an available vehicle 50 is located in the first parking lot P1 and a parking space available for the operated vehicle 50A is included in the second parking lot P2. In addition, the CPU 33 makes setting for the operated vehicle 50A so that persons other than the user who has made a reservation request for the operated vehicle 50A are unable to make the reservation again. That is, the CPU 33 sets the operated vehicle 50A to a vehicle 50 that has been reserved. Then, the CPU 33 advances the process to step S14. Examples of operations performed in the reservation process include an operation in which the CPU 33 stores, in the storage device 36, information including the identification information of the reservation to be made by the reservation process, the reservation information IR, the identification information of the operated vehicle 50A, and the identification information of the user. To reserve a vehicle is to provide the operated vehicle 50A for a user before the user starts using the operated vehicle 50A such that persons other than the user will not use the operated vehicle 50A.

In step S14, the CPU 33 performs a first setting process. In the first setting process, the CPU 33 sets one of the parking spaces in the second parking lot P2 to be unavailable for the different vehicle (a vehicle different from the operated vehicle 50A). For example, the CPU 33 updates the parking lot information IP stored in the storage device 36 to decrease the number of available parking spaces in the second parking lot P2 by one. Thus, the CPU 33 sets one of the parking spaces in the second parking lot P2 to be available for the operated vehicle 50A arriving at the second parking lot P2. Then, the CPU 33 advances the process to step S15.

In step S15, the CPU 33 makes a reservation completion notification. Specifically, the CPU 33 makes a notification indicating that the reservation of the operated vehicle 50A is completed from the transmission-reception device 31 to the operation terminal 60 of the user. Then, the CPU 33 advances the process to step S16.

In step S16, the CPU 33 determines whether the operated vehicle 50A has departed. Specifically, the CPU 33 refers to the position information PI of the operated vehicle 50A sent from the client terminal 20, and determines that the operated vehicle 50A has departed when the position of the operated vehicle 50A changes. In a case in which the operated vehicle 50A has not departed (S16: NO), the CPU 33 repeats the process of step S16. In a case in which the operated vehicle 50A has departed (S16: YES), the CPU 33 advances the process of step S17.

In step S17, the CPU 33 determines whether the operated vehicle 50A has moved out of the range of a first geofence G1. This determination is made based on the position information PI of the operated vehicle 50A sent from the client terminal 20. When the position of the operated vehicle 50A changes from the inside to the outside of the range of the first geofence G1, the CPU 33 determines that the operated vehicle 50A has moved out of the range of the first geofence G1. In a case in which the operated vehicle 50A has not moved out of the range of the first geofence G1 (S17: NO), the CPU 33 repeats the process of step S17. In a case in which the operated vehicle 50A has moved out of the range of the first geofence G1 (S17: YES), the CPU 33 advances the process to step S18. The first geofence G1 includes the entire region of the first parking lot P1 and does not include the region of the second parking lot P2.

In step S18, the CPU 33 performs a second setting process. In the second setting process, the CPU 33 sets one of the parking spaces in the first parking lot P1 to be available for the different vehicle. For example, the CPU 33 updates the parking lot information IP stored in the storage device 36 to increase the number of available parking spaces in the first parking lot P1 by one. As a result, the CPU 33 sets one of the parking spaces in the first parking lot P1 to be available for the different vehicle. Then, the CPU 33 advances the process to step S19.

In step S19, the CPU 33 determines whether the operated vehicle 50A has arrived at the second parking lot P2. The CPU 33 determines that the operated vehicle 50A has arrived at the second parking lot P2 when the following two conditions are satisfied. The first condition is that the operated vehicle 50A is located within the range of a second geofence G2. Specifically, the CPU 33 refers to the position information PI of the operated vehicle 50A sent from the client terminal 20 to determine that the first condition is satisfied when the operated vehicle 50A is located within the range of the second geofence G2. The second geofence G2 includes the entire region of the second parking lot P2 and does not overlap the first geofence G1.

The second condition is that a signal indicating that the use of the operated vehicle 50A has ended is received from the operation terminal 60 of the user. Specifically, the CPU 33 determines that the second condition is satisfied when the transmission-reception device 31 receives a signal indicating that the use of the operated vehicle 50A has ended from the operation terminal 60. When these two conditions are both satisfied, the CPU 33 determines that the operated vehicle 50A has arrived at the second parking lot P2. That is, the CPU 33 determines that the operated vehicle 50A has arrived at the second parking lot P2 when the signal indicating that the use of the operated vehicle 50A has ended is received with the operated vehicle 50A located within the range of the second geofence G2.

In a case in which the operated vehicle 50A has not arrived at the second parking lot P2 (S19: NO), the CPU 33 repeats the process of step S19. In a case in which the operated vehicle 50A has arrived at the second parking lot P2 (S19: YES), the CPU 33 updates the reservation information IR such that the reservation state of the operated vehicle 50A changes to an unreserved state. Then, the CPU 33 terminates the series of processes.

As described above, when affirmative determinations are made in steps S16 and S17, the CPU 33 performs the second setting process of step S18. The second setting process is a process that sets one of the parking spaces in the first parking lot P1 to be available for the different vehicle when the operated vehicle 50A departs toward the second parking lot P2 and then moves out of the range of the first geofence G1. As a result of the second setting process, the parking lot information related to one of the parking spaces in the first parking lot P1 is rewritten from a state indicating that the different vehicle is unavailable to a state indicating that the different vehicle is unavailable.

The CPU 33 performs the second setting process of step S19 before step S18. Until an affirmative determination is made in step S19 after an affirmative determination is made in step S17, the operated vehicle 50A is located outside the range of the first geofence G1 and outside the range of the second geofence G2. Thus, in the second setting process, the CPU 33 rewrites the parking lot information IP by the time the operated vehicle 50A arrives at the second parking lot P2, thereby setting one of the parking spaces in the first parking lot P1 to be available for the different vehicle.

### Operation of Embodiment

A process in which the operated vehicle 50A moves from the first parking lot P1 to the second parking lot P2 from a state in which the operated vehicle 50A is reserved as shown in FIG. 2 will now be described. In the state in which the operated vehicle 50A is reserved, the operated vehicle 50A is located in one of the parking spaces in the first parking lot P1. Thus, the one of the parking spaces in the first parking lot P1 that includes the operated vehicle 50A is unavailable for the different vehicle. Further, in the state in which the operated vehicle 50A is reserved, the different vehicle is not located in one of the parking spaces in the second parking lot P2. Thus, the parking lot information IP associated with the one of the parking spaces in the second parking lot P2 indicates that the operated vehicle 50A is available.

There is a case in which the operated vehicle 50A departs from the first parking lot P1 and then moves out of the range of the first geofence G1. In this case, the CPU 33 of the sharing management device 32 performs the second setting process to set the parking lot information IP related to the parking spaces in the first parking lot P1 such that the parking lot information IP indicates that the different vehicle is available.

From the above, when the operated vehicle 50A departs from the first parking lot P1 and then arrives at the second parking lot P2, the parking spaces in the second parking lot P2 are available for the operated vehicle 50A. When the operated vehicle 50A moves out of the range of the first geofence G1, that is, from when the operated vehicle 50A departs from the first parking lot P1 to when the operated vehicle 50A arrives at the second parking lot P2, the parking space in the first parking lot P1 that has been used by the operated vehicle 50A may be used by the different vehicle.

### Advantages of Embodiment

(1) In the above embodiment, one of the parking spaces in the first parking lot P1 is managed to be available for the different vehicle by the time the operated vehicle 50A arrives at the second parking lot P2. That is, the sharing management device 32 shortens the period of time during which one operated vehicle 50A uses two parking spaces. Accordingly, the parking spaces in the first parking lot P1 are managed more efficiently.

(2) As the parking spaces in the first parking lot P1 are set to be available for the different vehicle at an earlier time, the parking spaces in the first parking lot P1 can be used more effectively. For example, the parking spaces in the first parking lot P1 are made available for the different vehicle more quickly by setting the parking spaces in the first parking lot P1 to be available for the different vehicle when the operated vehicle 50A departs toward the second parking lot P2. However, in this case, if the user returns to the first parking lot P1 for some reason (e.g., returns to pick up a forgotten object), there may be no available parking space and the user may be unable to park the operated vehicle 50A.

In the above embodiment, the parking spaces in the first parking lot P1 are set to be available for the different vehicle on condition that the operated vehicle 50A has moved out of the range of the first geofence G1. That is, in a case in which the operated vehicle 50A has traveled a considerable distance and has a relatively high possibility of not returning to the first parking lot P1, the parking spaces in the first parking lot P1 are set to be available for different vehicle. This limits the above situations, in which there is no available parking space when the user returns to the first parking lot P1.

(3) In the above embodiment, the sharing management device 32 manages not only the parking spaces in each parking lot but also the vehicle 50 used in the car sharing system 10. Upon a reservation request for the operated vehicle 50A, the sharing management device 32 performs the reservation process to reserve the operated vehicle 50A. In the reservation process, the CPU 33 of the sharing management device 32 reserves the operated vehicle 50A on condition that an available operated vehicle 50A is located in the first parking lot P1 and a parking space available for the operated vehicle 50A is included in the second parking lot P2. Thus, when the operated vehicle 50A arrives at the second parking lot P2, the second parking lot P2 is available for the operated vehicle 50A. This avoids situations in which the parking spaces in the second parking lot P2 are unavailable when the operated vehicle 50A arrives at the second parking lot P2.

(4) In the above embodiment, the sharing management device 32 of the car sharing system 10 determines whether the operated vehicle 50A has moved out of the range of the first geofence G1 based on the position information PI of the operated vehicle 50A received from the client terminal 20. This eliminates the need for a special device that determines the positional relationship between the operated vehicle 50A and the first parking lot P1.

### Modifications

The above embodiment may be modified as follows. The above embodiment and the following modifications can be combined as long as the combined modifications remain technically consistent with each other.

### Client Terminal

The client terminal 20 is not limited to a vehicle on-board device. For example, if the operation terminal 60 includes the position information acquisition device 21 and the transmission device 22, the client terminal 20 may be the operation terminal 60 of the user. If the user carries the operation terminal 60, the position of the operation terminal 60 can be regarded as the position of the operated vehicle 50A. In addition, the client terminal 20 does not have to be one device, and may be a combination of devices that are independent from each other. For example, the client terminal 20 may be a combination of the position information acquisition device 21 mounted on the vehicle 50 and the transmission device 22 included in the operation terminal 60. In this modification, the position information acquisition device 21 and the transmission device 22 may communicate with each other through near-field communication or the like.

### Sharing Management Device

In addition to the sharing management device 32, the server 30 may include a vehicle management device that manages the vehicles 50. In this case, the sharing management device 32 may execute the first setting process of step S14 and the second setting process of step S18, whereas the vehicle management device may execute the processes of the other steps.

The sharing management device 32 may include:

A) processing circuitry including one or more processors that execute various processes in accordance with a computer program (software);

B) processing circuitry including one or more dedicated hardware circuits such as application specific integrated circuits (ASICs) that execute at least part of various processes; or

C) processing circuitry including a combination thereof

The processor includes a CPU and memories, such as a RAM and a ROM. The memory stores program codes or instructions configured to cause the CPU to execute the processes. The memory, or a computer-readable medium, includes any type of medium that is accessible by general-purpose computers and dedicated computers. The same applies to the other devices.

### Second Setting Process

The CPU 33 of the sharing management device 32 only needs to execute the second setting process by the time the operated vehicle 50A arrives at the second parking lot P2 from when the operated vehicle 50A departs toward the second parking lot P2. For example, step S17 may be omitted. In this case, after determining in step S16 that the operated vehicle 50A has departed, the CPU 33 proceeds to step S18 and executes the second setting process. Instead, for example, instead of the process in step S17, the CPU 33 may determine whether a predetermined period of time or more has elapsed since the departure of the operated vehicle 50A. In this case, the CPU 33 may execute the second setting process when a certain period of time or more has elapsed since the departure of the operated vehicle 50A. Alternatively, for example, instead of the process in step S17, the CPU 33 may determine whether the operated vehicle 50A has traveled a predetermined distance or more has elapsed since the departure of the operated vehicle 50A. In this case, the CPU 33 may execute the second setting process when the operated vehicle 50A has moved a certain distance or more since the departure of the operated vehicle 50A. In these modified examples, the storage device 36 does not need to store the geofence information IG.

The CPU 33 may determine the time at which the second setting process is performed regardless of the position information PI of the operated vehicle 50A. For example, in a case in which a near-field communication device is installed in a range including the first parking lot P1 and the near-field communication device and the client terminals 20 can communicate with each other, the following process is performed. First, when the client terminal 20 cannot communicate with the near-field communication device, the client terminal 20 or the near-field communication device sends a signal indicating that the client terminal 20 cannot communicate with the near-field communication to the server 30. When the transmission-reception device 31 of the server 30 receives the signal, the sharing management device 32 performs the second setting process.

Alternatively, for example, in a case in which the first parking lot P1 includes a communication device capable of communicating with the server 30 via the external communication network 40 and a detection device that detects entry and exit of the vehicle 50 to and from the first parking lot P1, the following process is performed. First, the detection device detects that the operated vehicle P1 has left the first parking lot P1. After the operated vehicle 50A leaves the first parking lot P1, the communication device sends a signal indicating that the operated vehicle 50A will depart to the server 30. After the server receives the signal, the sharing management device 32 determines that the operated vehicle 50A has departed from the first parking lot P1 toward the second parking lot P2. Then, the sharing management device 32 performs the second setting process.

The CPU 33 may determine whether the operated vehicle 50A has departed regardless of the position information PI of the operated vehicle 50A. For example, when the operation terminal 60 of the user is operated to perform an operation to start using the operated vehicle 50A, the CPU 33 may determine that the operated vehicle 50A has departed. Specifically, the CPU 33 may determine that the operated vehicle 50A has departed by acquiring a signal based on the operation from the operation terminal 60. When a power switch of the operated vehicle 50A is operated to power on the operated vehicle 50A, the CPU 33 may determine that the operated vehicle 50A has departed. For example, the CPU 33 may determine that the operated vehicle 50A has departed when acquiring, from the client terminal 20, a signal indicating that the operated vehicle 50A has been powered on.

After the operation to start using the operated vehicle 50A is performed or after the power switch of the operated vehicle 50A is operated, the operated vehicle 50A may remain stopped in the parking space in the first parking lot P1 for a while. Thus, the CPU 33 may determine that the operated vehicle 50A has departed when a predetermined period of time has elapsed after the operation to start using the operated vehicle 50A is performed, or when a predetermined period of time has elapsed after the power switch of the operated vehicle 50A is operated.

When the same parking lot as the first parking lot P1 is set as the second parking lot P2, the first and second setting processes do not have to be performed. That is, a parking space in the parking lot set as the first parking lot P1 and the second parking lot P2 are set such that the parking space is always unavailable for the different vehicle during a period in which the parking space is used by the operated vehicle 50A.

### Other Modifications

The operated vehicle 50A is not limited to the target vehicle to be shared by users. For example, even if the operated vehicle 50A is owned by a user, the parking spaces in the parking lot only need to be shared by multiple users. In this case, by operating the operation terminal 60, the users check the availability of the parking spaces in the second parking lot P2 and request the server 30 to perform the first setting process before starting the operated vehicle 50A.

The vehicle 50 is not limited to an automobile and may be a bicycle. The vehicle 50 is not limited to a four-wheeled vehicle and may be, for example, a three-wheeled vehicle or a two-wheeled vehicle.

Parking spaces for sharing and parking spaces that are not for sharing may be included in one site. In this case, the range of a geofence only needs to be set to include the entire parking spaces managed by the sharing management device 32 for sharing. That is, the geofence may be set so as not to include parking spaces that are not for sharing.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A sharing management device configured to perform management for a user to share a parking space in a parking lot, wherein
a vehicle moving from a first parking lot having one or more parking spaces to a second parking lot having one or more parking spaces is referred to as an operated vehicle,
a vehicle that is different from the operated vehicle is referred to as a different vehicle,
the sharing management device comprises processing circuitry configured to execute:
a first setting process that sets one of the one or more parking spaces in the second parking lot to be unavailable for the different vehicle before the operated vehicle departs from the first parking lot toward the second parking lot; and
a second setting process that sets one of the one or more parking spaces in the first parking lot to be available for the different vehicle from when the operated vehicle departs from the first parking lot toward the second parking lot to when the operated vehicle arrives at the second parking lot.

2. The sharing management device according to claim 1, wherein the second setting process includes setting the one of the one or more parking spaces in the first parking lot to be available for the different vehicle when the operated vehicle departs from the first parking lot toward the second parking lot and then moves out of a range of a geofence that includes the first parking lot and does not include the second parking lot.

3. The sharing management device according to claim 1, wherein
the operated vehicle is a target vehicle to be shared by a user,
the processing circuitry is configured to execute a reservation process that reserves the operated vehicle when receiving a reservation request for the operated vehicle moving from the first parking lot to the second parking lot, and
the reservation process is a process that reserves the operated vehicle on condition that the operated vehicle is located in the first parking lot and a parking space available for the operated vehicle is included in the second parking lot.

4. A sharing system, comprising:
a server including the sharing management device according to claim 2; and
a client terminal capable of communicating with the server, wherein
the client terminal includes a transmission device configured to send position information of the operated vehicle to the server,
the server includes a reception device configured to receive the position information of the operated vehicle sent from the transmission device, and
the processing circuitry is configured to determine whether the operated vehicle has moved out of a range of the geofence based on the position information of the operated vehicle.
